(19) United States
(12) Patent Application Publication
(10) Pub. No.: US 2026/0330146 A1
(43) Pub. Date: Oct. 22, 2026

(54) Modular Application Programming Interfaces for Artificial Intelligence Agents

(71) Applicant: The Board of Trustees of the University of Illinois, Urbana, IL (US)

(72) Inventors: Jimeng Sun, Las Vegas, NV (US); Zifeng Wang, Urbana, IL (US); Benjamin Danek, Urbana, IL (US)

(21) Appl. No.: 19/181,109

(22) Filed: Apr. 16, 2025

(51) Int. Cl. G06F 40/40; G06F 9/451; G06F 9/54

(52) U.S. Cl. CPC G06F 40/40; G06F 9/451; G06F 9/541

(57) ABSTRACT

An embodiment includes a method. The method includes based on a user query, selecting an agent avatar from a plurality of agent avatars. The method also includes providing, to a natural language model, the selected agent avatar such that the natural language model operates according to the selected agent avatar. The method also includes identifying, by the natural language model, a resource associated with the user query. The method also includes accessing, via an application programming interface, the resource associated with the user query. The method also includes receiving, from the resource associated with the user query, information related to the user query. The method also includes synthesizing, by the natural language model, the user query and the information related to the user query. The method also includes generating, by the natural language model, a response.

### BACKGROUND

Researchers typically engage in programming to extract valuable insights from datasets, subsequently presenting these findings to other involved parties for informed decision-making. In some situations, this process can drag on for months due to communication gaps and inefficient workflows. Integrating generative artificial intelligence (GenAI) models such as large language models (LLMs) into this workflow is one approach that may present options to expedite this process. The benefits of such approaches are two-fold: researchers can develop new functions and try new ideas quicker and more efficiently by consulting suggestions generated by LLMs, and other involve parties can interact with an interface powered by LLMs to access instant data insights. As such, they hold the potential to transform collections of data into actionable real-world evidence. This may then be used to advance scientific research.

Generalist-type LLMs that are often trained using extensive web-based text corpora have shown remarkable abilities in text processing and generation. To improve their proficiency in generating code, some approaches have focused on training these LLMs with a broad range of open-source codebases. Such code-focused LLMs form the foundation for coding agents. These systems primarily function by taking the coding context (e.g., previously written code or code libraries) into account and suggesting complete statements or code blocks, operating similarly to an auto-completion tool.

However, challenges may arise when these coding agents are applied to research projects, such as those concerned with data science. These projects tend to be more complex, often featuring ambiguous or high-level problem statements and methodologies, making it harder for the coding agents to provide viable code suggestions. As a result, users of such agents may find themselves spending significant time inspecting the suggested code and frequently opt to write the code themselves due to these limitations.

Some approaches to enhancing the data science code generation capabilities of LLMs have also been proposed. These approaches have the ability to craft concise code in standalone snippets for solving some basic data science challenges, while more sophisticated agents using LLM agents have also emerged. These agents can provide elementary planning to assimilate domain-specific knowledge, access software library documentation, and conduct data analysis interactively. However, their conversational approach necessitates intricate prompt engineering (e.g., meticulous construction and planning for the prompts provided to the LLM) to effectively grasp the context and align with user intentions, which can be difficult for those unfamiliar with AI systems.

Research coding agents also often need to be able to provide both effective code execution and analysis planning guidance. Following the data science example from above, coding in this field often takes place in computational notebooks (e.g., Jupyter Notebook, among others) where the code is typically unstructured and may follow a non-linear execution pattern. To generate useful code, a coding agent then should comprehend the full context, including comments and logs, and tailor the code to the user's intentions and skill level. The generated code should also fit the users' coding capabilities and evolve with them over time when deepening the understanding of the data and the task. This type of coding agent may also provide planning assistance because a lack of thoughtful planning can lead to misguided code execution, resulting in ineffective or misleading outcomes.

In the context of medical research, several other challenges arise. One is the knowledge gap between different users of the same AI agent. An AI agent for medical data science must accommodate users with varying expertise due to the high domain knowledge requirement in medical data science. For instance, data scientists often face difficulties in data processing and may lack medical knowledge crucial for analytical planning. Conversely, medical professionals often do not have the coding skills to effectively communicate with AI agents. The collaboration between these two groups traditionally involves extensive discussions and alignment in the planning phase, often requiring iterative processes with literature searches and revisions at multiple stages. The use of LLMs in medical research also poses several challenges, including data privacy concerns and code integration.

Data privacy is a critical concern when using LLM for medical data, prohibiting access to individual patient records. This contrasts with other approaches such as code interpreters, which typically rely on complete data access to generate accurate code.

In data science, referencing past analyses is often crucial for inspiration and as a start for new projects. However, these analyses are often scattered across various code bases. Therefore, the agent must not only facilitate code search and recommendations but also possess the ability to contextualize and execute previous analyses in new projects. This requires sophisticated design in retrieval-augmented generation (RAG) to seamlessly transfer insights from past codes to new endeavors.

### SUMMARY

To address the issues described above, this disclosure includes an AI agent tailored for medical data science discovery using LLMs. The agent synthesizes information from several sources and can interact with code servers and other resources using a set of modular application programming interfaces (APIs). This provides a technical improvement, by providing more efficient and less time-consuming methods for searching and compiling information, as well as providing efficient and up-to-date feedback on code during the code writing process. This has the additional effect of reducing the consumption of limited computing resources, such as memory, disk space, and processor time.

The embodiments herein also include search system for documents, whether online or in an offline database, which can be useful in research contexts. In particular, the embodiments herein employs a dual approach, combining sparse retrieval with dense vector-based re-ranking. Initially, sparse retrieval, often through inverted index methods, is used for rapidly scanning extensive document collections. In this phase, the system processes structured search queries generated by LLMs, which encompass specific filters for certain document fields and essential search terms. This approach effectively identifies a relevant group of documents likely to hold the necessary information. Given that LLMs have a limited context window and can be overwhelmed by excessive information in the prompt, it is advisable to refine the information retrieved for the LLM. To accomplish this, dense vector-based re-ranking is employed. This stage involves a thorough analysis of the semantic links between the query and the initially retrieved documents, aiming to reorganize the documents. By doing so, the re-ranking process ensures that the final selection of documents is not only relevant but also optimally useful for addressing the specific query. This two-pronged approach is designed to maximize both the efficiency of document retrieval and the relevance and utility of the results for the LLM.

In a first example embodiment may involve a method. The method includes based on a user query, selecting an agent avatar from a plurality of agent avatars. The method also includes providing, to a natural language model, the selected agent avatar such that the natural language model operates according to the selected agent avatar. The method also includes identifying, by the natural language model, a resource associated with the user query. The method also includes accessing, via an application programming interface, the resource associated with the user query. The method also includes receiving, from the resource associated with the user query, information related to the user query. The method also includes synthesizing, by the natural language model, the user query and the information related to the user query. The method also includes generating, by the natural language model, a response.

A second example embodiment may involve a computing system that may include one or more processors, as well as memory and program instructions. The program instructions may be stored in the memory, and upon execution by the one or more processors, cause the computing system to perform operations in accordance with the first embodiment.

A third example embodiment may involve a non-transitory computer-readable medium, having stored thereon program instructions that, upon execution by a computing system, cause the computing system to perform operations in accordance with any of the previous example embodiments.

In a fourth example embodiment, a system may include various means for carrying out each of the operations of any of the previous example embodiments.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is an illustration of an AI system, according to example embodiments.

FIG. 2 is an illustration of a user interface, according to example embodiments.

FIG. 3 is an illustration of an agent avatar module, according to example embodiments.

FIG. 4A is an illustration of a message flow diagram for a code execution API, according to example embodiments.

FIG. 4B is an illustration of a message flow diagram for a codebase search API, according to example embodiments.

FIG. 4C is an illustration of a message flow diagram for a web or document search API, according to example embodiments.

FIG. 5A is an illustration of a codebase, according to example embodiments.

FIG. 5B is an illustration of code and annotations, according to example embodiments.

FIG. 6 is an illustration of a method, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

### I. LARGE LANGUAGE MODELS (LLMS)

### A. Overview of LLMs

An LLM is an advanced computational model, primarily functioning within the domain of natural language processing (NLP) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

### B. Prompt Engineering

Prompting is a key part of LLM usage. This process involves crafting inputs for LLMs. A mathematical representation of LLMs includes three main components: context (C), instruction (T), and input (X). The context C is defined as C={S, H}, where S represents the system message (also known as a system prompt). This message outlines the objectives of the LLM, essentially instructing the LLM as to what it will do. For example, such a system message may include background information on the task the LLM is to perform, the inferred user portrait, and the role the LLM is expected to fulfill.

The second element of the context, H, denotes the interaction history, typically in the form of chat logs (past messages and responses between the LLM and a user) within the current session. This history helps remind the LLM of pertinent background information and aids in decision-making. The instruction T delineates the specific task that the LLM is to execute in this instance. It may be conveyed through textual descriptions and/or function call directives (e.g., in JSON format), which may define the structure to which the output should adhere.

The input (X) originates from user queries in natural language or from responses generated by APIs or other LLMs. The prompting function is denoted as P(⋅), which may be responsible for converting raw input into a format that is suitable for processing by LLMs. This function can be expressed as P(C, T, X), where C, T, and X represent context, instruction, and input, respectively, as described above.

The inference process of the LLM agent is then described by the equation X=LLM (P(C,T,X)). To improve the effectiveness of prompting, a technique known as retrieval-augmented generation (RAG) may be used. This approach dynamically incorporates knowledge into the LLM at the time of inference (i.e., as opposed to at the time of training), facilitating knowledge-grounded generation. RAG is often accomplished through a retrieval function R(⋅), which takes the input and performs either sparse or dense retrieval. This retrieval process extracts the most pertinent documents from a database or the most relevant code snippets from a codebase. Consequently, the output in this enhanced scenario is represented by the equation \hat{X}=LLM (P(C,T,X), R(X; K)), where K denotes an external knowledge base.

Few-shot prompting is a variation of the RAG method. In this approach, the input X is used to fetch a collection of example inputs and their corresponding outputs from the reference database, represented as {Xᵢ, \hat{X}ᵢ}^{K}=R_{F}(X, χ). This process is known as K-shot prompting, where K denotes the number of example pairs utilized. Few-shot prompting is particularly effective in aligning the LLM more closely with the specific task at hand, as it supplements the model's outputs by referencing high-quality, or “golden standard”, examples. For instance, this method can be employed to guide the LLM to generate code in a particular style by retrieving and using relevant examples from a codebase as a template or reference.

### II. MODULAR APIS FOR ARTIFICIAL INTELLIGENCE AGENTS

The following description and accompanying drawings will elucidate features of various example embodiments. The embodiments provided are by way of example, and are not intended to be limiting. As such, the dimensions of the drawings are not necessarily to scale.

### A. Overview of AI Agent System

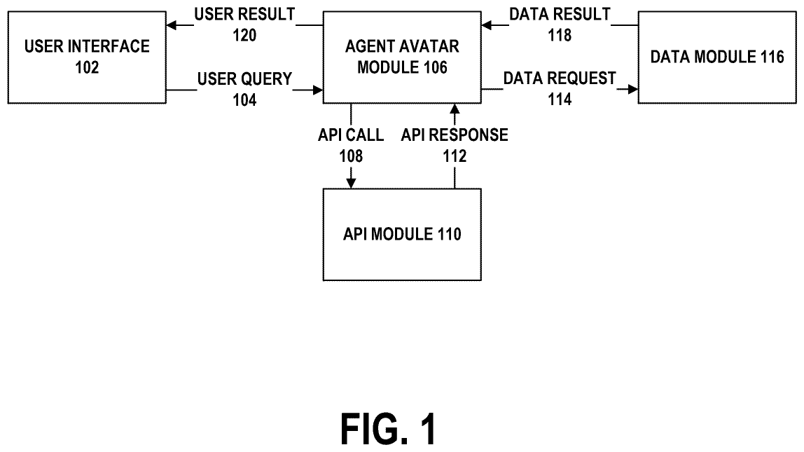

FIG. 1 is an illustration of a system 100, which includes several components involved in an AI agent employing modular APIs, as described above. The system 100 includes four key components: a user interface 102, an agent avatar module 106, an API module 110, and a data module 116.

The system 100 may be tailored to serve a wide range of users and their specific needs. For instance, using the example from above, the users may be involved in medical research Thus, the system 100 may be configured to enable these users to access a variety of support tools for conducting medical data science research, leveraging real-world data such as patient records from clinical trials.

The core of the system is are one or more AI-powered agents that make use of LLMs, housed in the agent avatar module 106. This agent is capable of processing user queries related to analysis planning or code execution. To cater to the diverse needs of different users, the agent may use different “avatars”. Each avatar may be uniquely programmed with specific prompts to suit various use cases and user preferences during the interactive sessions.

Additionally, the agent avatar module 106 coordinates a variety of APIs to manage complex operations and retrieve information that may be helpful in responding to a user's query. Such APIs are automatically invoked by the system 100 through the API module 110 to convert natural language inputs into structured API calls.

Using the data module, the system 100 may access both open data sources, like research publications, and proprietary data, such as specific patient datasets. A distinct separation is often maintained between these data types to ensure varying levels of data privacy throughout the system.

In action, the components of the system 100 may interact with one another to respond to user input and/or action. For instance, in response to a user's action, the user interface 102 may transmit a user query 104 to the agent avatar module 106. The agent avatar module 106 may determine that an API call is necessary, and transmit an API call 108 to the API module 110, which may perform actions such as remote code execution. The API module 110 may then provide an API response 112 to the agent avatar module 106. If the agent avatar module 106 determines that data available to the data module 116 is relevant to the user query 104 and/or api response 112, it may transmit a data request 114 to the data module 116, which may retrieve related data and provide a data result 118 to the agent avatar module 106.

After these actions, the agent avatar module 106 may synthesize information from the user query 104, api response 112, and data result 118 to provide a user result 120 for display to the user by way of the user interface 102. This synthesis make take place using an LLM or other AI system.

The subsequent sections will delve into the details of each of these components in turn.

### B. User Interfaces

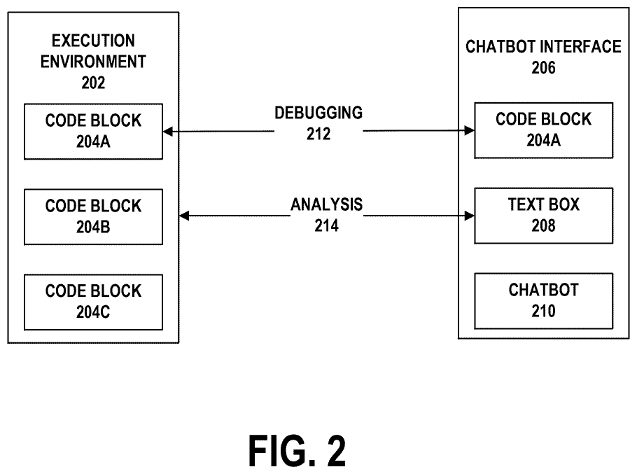

The user interface 102 is described in further detail in FIG. 2. The user interface 102 is designed to enhance user interaction with the system 100 through two constituent modules: the execution environment 202 and chatbot interface 206. Unlike other approaches that are restricted to chat interactions, which necessitate sequential communication and hinder the ability to multitask, the user interface 102 overcomes these limitations. Traditional systems also demand carefully prompt crafting to provide context and instructions to LLMs, a process that can significantly reduce productivity. In contrast, the embodiments herein offer a variety of available options, allowing users to swiftly engage with the functionalities they need without the burden of creating prompts. This interface is structured to provide a series of interactions tailored for efficiency and ease of use.

The execution environment 202 is designed to support code development and execution, and may include an integrated development environment (IDE) or other similar system where users write, test, and refine their code blocks. When a user encounters a code block (e.g., code block 204A) that requires debugging or improvement, they may turn to the chatbot interface 206. This module is capable of analyzing the problematic code (as shown in FIG. 2, where the chatbot interface 206 is debugging code block 204A) and offering enhanced or corrected versions.

Additionally, users in the execution environment 202 can use the module to infer the next logical step in their coding sequence, receiving suggestions on what code blocks to implement next in their analysis. For instance, based on code blocks 204A and 204B, the execution environment 202 may provide a suggested or inferred ode block 204C. In the chatbot interface 206, a chatbot 210 (which may in some embodiments be powered by an LLM) is accessible via a common AI system prompt-and-answer interface and may assist users with brainstorming, exploration, and planning. This feature encourages a cooperative dialogue to steer the direction of the data science project. Additionally, the agent reviews the whole data pipeline and offers in-depth actionable advice and/or analysis 214 within a text box 208. Users can take this curated feedback to the execution environment 202, applying it to refine their code blocks or develop more analytics. This user interface 102 thus is engineered for specific user tasks, reducing the need for intricate prompt construction and enabling the parallel execution of tasks, significantly optimizing productivity.

### C. Agent Avatars

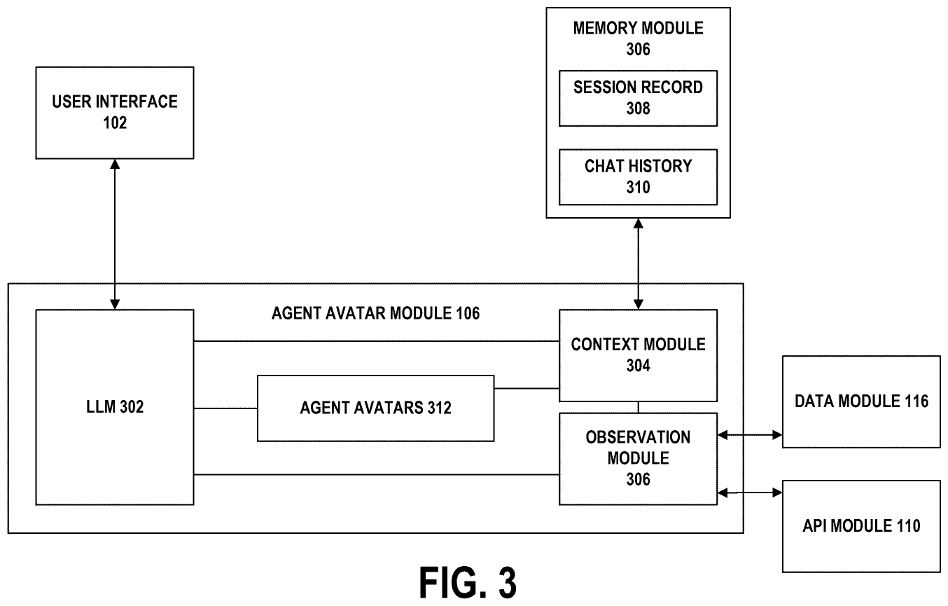

The agent avatar module 106 of FIG. 1 is described in further detail in FIG. 3. The agent avatar module 106 functions as an orchestrator for the entire system 100, and may include an LLM 302, context module 304, and observation module 306. This component uses the terminology of agent “avatars” as the AI system can adopt different avatars to interact with different types of users and use-cases. This primarily occurs through modifications to the system prompt S, which is often integral to defining the capabilities and roles of LLM agents. By modifying S, the personality of an agent can be significantly altered, enabling a shift from complex tasks like advanced coding assistance to more fundamental roles such as tutoring at an elementary school level. This adaptability facilitates the creation of a variety of agent avatars, each customized for distinct scenarios, through adjustments to S. The flexibility inherent in this design allows for a broad range of applications and user interactions, catering to diverse needs and scenarios.

The agent avatar module 106 may include several agent avatars 312, which may enable the system 100 to seamlessly switch among several operational modes, including exploration, code execution, code planning, and reflection. Each of the modes affects the behavior of the AI system.

In exploration (or search-focused) mode, the agent engages deeply with the user, striving to understand their current analytical approach, proficiency in coding and statistics, domain-specific insights, and overall aims. This understanding is facilitated through an analysis of previous chat dialogues and interactions. Additionally, this mode allows for high-level brainstorming about data science strategies, gathering of external knowledge, and gaining a comprehensive grasp of various data models.

In code execution mode, the agent concentrates on devising coding solutions, implementing code, and performing debugging tasks. Meanwhile, the code planning mode involves the agent offering in-depth guidance on coding strategies. This includes presenting step-by-step methodologies in pseudo-code and explanatory notes to help users achieve their coding objectives.

The reflection mode is engineered to offer a detailed review of the entire project workflow. This mode is instrumental in identifying any overlooked steps, critically analyzing previous phases, and proposing alternative conceptual strategies. Its unique requirement for a wide-ranging context makes the use of context compression techniques vital, ensuring the agent maintains focus on pertinent information and avoids overlooking essential aspects of the analysis.

The system prompt S is structured to include two distinct components: S={Sₐᵥₐ, Sᵤₛᵣ}, which are the avatar prompt and the user-specific prompt, respectively. For the avatar prompt, Sₐᵥₐ, we have predefined it into four distinct categories to align with the operational modes of the system: exploration code execution

$$( {S}_{ava}^{ex} ) ,$$

code execution

$$( {S}_{ava}^{ce} ) ,$$

code planning

$$( {S}_{ava}^{cp} ) ,$$

and reflection

$$( {S}_{ava}^{re} ) .$$

Each category tailors the avatar's communication style and function to the specific mode. During every interaction using the LLM 302 and the user interface 102, the agent avatar module 106 determines the most appropriate mode of the agent avatars 312 to operate in, or alternatively, the user can choose to explicitly select a specific mode for the agent to follow.

The other component of S, Sᵤₛᵣ, is dynamically tailored to each user, evolving based on the history of interactions. This component of the system prompt captures a summary of past conversations and deduces the user's unique characteristics, such as their intended analysis plan and coding skills. As a result, Sᵤₛᵣ is continually updated throughout the interactive session to maintain relevance and accuracy. When there is a shift in the operational mode, the prompt changes accordingly to suit the new task at hand, ensuring that both the avatar and user-specific prompts are in synchrony with the current objective and user needs.

In order to continually update Sᵤₛᵣ, the agent avatar module 106 utilizes two memory types stored in the memory module 306 for information storage and retrieval: the current chat session memory record 308, or

$${ℋ}_{cs} = \{ {H}_{cs}^{1} , … , {H}_{cs}^{N} \} ,$$

where each

$${H}_{cs}^{n}$$

denotes a single interaction round, and the chat history 310, or [symbol] ₚₛ, which serves as a persistent database archiving all of the user's chat history.

A progressive inference process is employed by the context module 304 in interaction with the other components of the agent avatar module 106 to ensure the user-specific prompt remains up-to-date. During the n-th round, the first step of this process involves the LLM 302 summarizing the preceding chat logs. This is achieved by compressing the chat context

$${\hat{H}}_{cs}^{n} = LLM ( P ( \{ {\hat{H}}_{cs}^{n - 1} , {H}_{cs}^{n} \} ) ) ,$$

progressively.

Following this, the user-specific prompt is updated by considering both the newly compressed context

$${\hat{H}}_{cs}^{n}$$

and information from the persistent chat history 310 [symbol] ₚₛ. The agent searches the persistent history for queries and responses similar to the current context, resulting in

$${\hat{H}}_{ps}^{n} = R ( {\hat{H}}_{cs}^{n} ; {ℋ}_{ps} ) .$$

Consequently, the user-specific prompt for the current round is formed as

$${S}_{usr}^{n} = LLM ( P ( \{ {S}_{usr}^{n - 1} , {\hat{H}}_{cs}^{n} , {\hat{H}}_{ps}^{n} \} ) ) ,$$

integrating both the latest interaction and relevant data from the chat history 310.

As shown in FIG. 1, the user interface 102 may transmit a user query 104 to the agent avatar module 106 and responsively receive a user result 120. As shown in FIG. 3, this user query may come through a chatbot (e.g., the chatbot 210 of FIG. 2) and be provided to an LLM 302, which may then interact with other components in the agent avatar module 106 such as the context module 304, observation module 306, and agent avatars 312 (as well as external modules such as the memory module 306, API module 110, and data module 116) to craft a response.

In some embodiments, to support the above operations, the LLM 302 may use a chain-of-thought (CoT) prompting framework, such as ReAct. CoT involves breaking down the target task into a sequence of smaller, more manageable steps, denoted as {t₁, t₂, . . . , tₛ}. The LLM 302 is then prompted to generate corresponding outputs for each step in a single pass, represented as {x₁, \hat{x}₂, . . . , \hat{x}ₛ}. This approach is essential for eliciting the thought process of the LLM 302 and fostering its ability in planning and self-reflection. The step-by-step resolution of complex tasks has been shown to markedly enhance the quality of the end results in some situations.

With CoT, the LLM 302 gains the capability to induce, monitor, and revise its action plans. Building upon CoT, ReAct and similar frameworks further integrates interaction with external tools, enabling the LLM to retrieve additional information necessary for the intermediate steps. In the embodiments herein, these external tools may _{S} include the API module 110 and data module 116. While CoT guides the LLM to follow a predetermined plan for sub-steps, ReAct and its ilk encompass a dynamic interplay of reasoning (RS), acting (AT), and observing (OB). This approach effectively decomposes the target task into a sequence of these three types of events, transforming the output & into a series of such events.

At the s-th step, the input includes all the preceding intermediate steps, expressed as \hat{X}_{1:S}={RS, AT, OB, RS . . . ). The LLM 302 then determines the next action to take at each step, formulated as \hat{x}ₛ=LLM (P(C,T,\hat{X}_{1:S})). Here, RS represents the thinking (or “reasoning”) process conveyed through textual descriptions, AT initiates an action using part of the context as input to an external tool, and OB refers to the responses received from these external tools.

For this reason, the component of the agent avatar module 106 that directs the external tools such as the API module 110 and data module 116 is the observation module 306, acting at the direction of the LLM 302 through the process described mathematically above. The external tools are described in further detail below.

### D. APIs

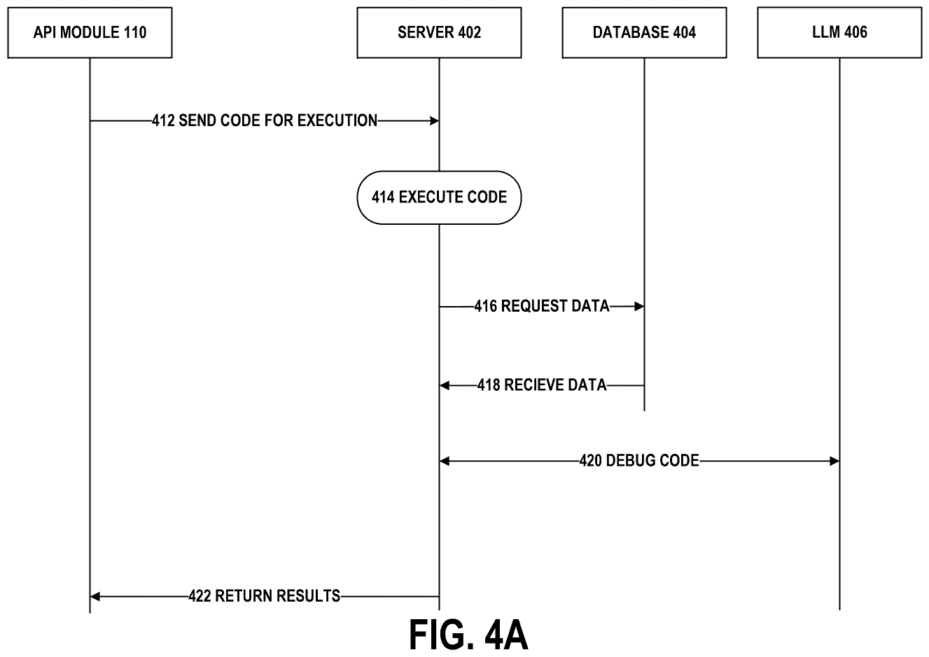

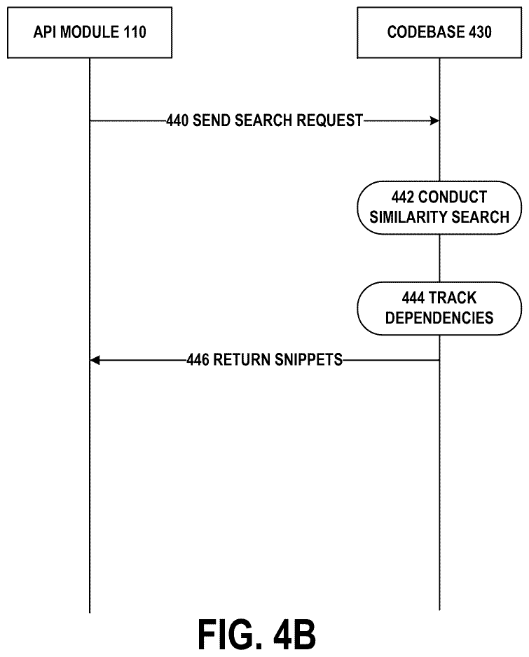

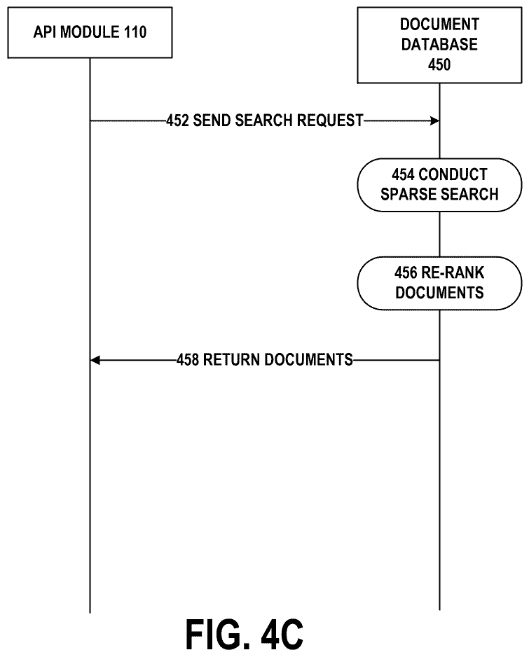

FIGS. 4A-4C illustrate several message flow diagrams of example APIs that may be run by the API module 110 on behalf of the agent avatar module 106 as described above.

FIG. 4A depicts a message flow diagram of a code execution API. The code execution API is designed to provide a privacy-focused environment for running and debugging code, as well as be able to protect sensitive and/or private data such as patient records in medical contexts. This protection is especially important when interfacing with external model service providers or other external services. The implementation of the code execution API is two-fold: firstly, the LLM may only interact with the data schema, not the data itself, when generating code. This approach ensures that the sensitive data remains undisclosed to the LLM. Secondly, in some embodiments, the code generated by the LLM 302 and sent to a server 402 and is executed in an isolated environment within the server 402 where the actual data resides. This isolated environment is responsible for processing the code and returning only the execution results and debugging logs without exposing the underlying data. In some embodiments, the data may be stored on a separate database and accessed by the server 402. Additionally, a specialized LLM 406 dedicated to debugging may be deployed. The LLM 406 engages with the outputs of the code execution. If the results are not as expected, the LLM 406 iterates through the process, interacting with the execution outcomes to refine the code. This process continues until the code functions correctly or reaches a predefined limit of trial-and-error attempts, ensuring both the efficacy of the code and the confidentiality of the data.

As shown in FIG. 4A and following the above, the API module 110, on behalf of the agent avatar module 106, may receive generated code from the LLM 302 and, as shown at arrow 412, send the code for execution by the server 402. As shown at block 414, the server 402 may then execute the code. As noted above, this code execution may occur within an isolated environment to avoid exposure of sensitive data. In embodiments where data required for code execution is not stored directly within the server 402, the server 402 may, as shown at arrow 416, request data from a database 404 and responsively receive data as shown at arrow 418. In some embodiments, this data retrieval may be facilitated by the data module 116.

The specialized LLM 406 may then be used to debug the code, as shown at arrow 420, and may perform a back-and-forth process until the code either functions correctly or another limit, which may be set by a user. Following these processes, the server 402 may then return the results to the API module 110, as shown at arrow 422. These results may then be made available to the agent avatar module 106 for further analysis by the LLM 302.

FIG. 4B depicts a message flow diagram of a codebase search API. The API module 110, on behalf of the agent avatar module 106, may send a search request to a codebase 430, as shown at arrow 440. In some embodiments, this search may be facilitated by the data module 116. Codebases may include both code snippets as well as “annotations,” information about the code snippet that may be useful for retrieval and/or use by code generation LLMs. For instance, annotations may identify functions, classes, and variables within the code snippet, or identify code dependencies required for that particular snippet to function. Annotations may also include a plain-language description of what the code snippet does.

As shown at block 442, the codebase 430 may conduct a similarity search (or any other type of search) to identify code snippets relevant to the search request. This may involve searching not only the code itself but also the annotations, as described above. Using the annotations, the codebase 430 may also identify dependencies for the identified code snippets, and such snippets that other snippets are dependent on may also be returned, as shown at block 444.

After the search process, the codebase 430 may return the code snippets (and, in some embodiments, their related annotations) to the API module 110, as shown at arrow 446. These may then be made available to the agent avatar module 106 for further analysis by the LLM 302.

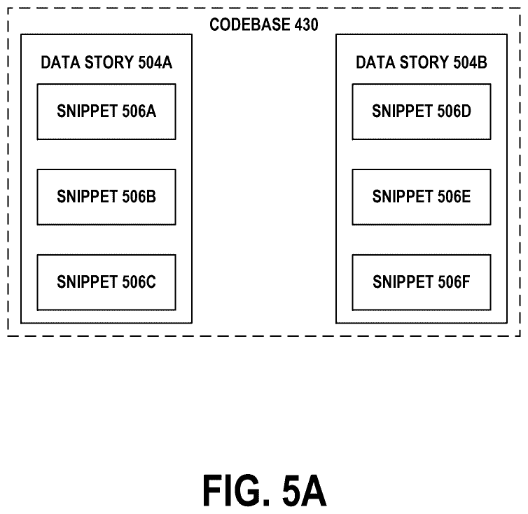

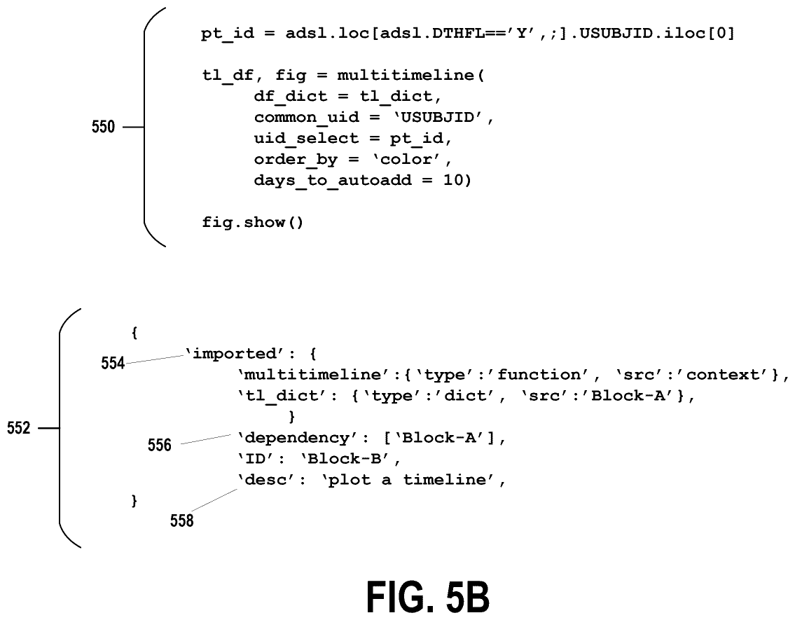

To support the search operations described above, codebases such as the codebase 430 may be structured and/or indexed in a particular manner, which will be described below with regard to FIGS. 5A and 5B.

FIG. 4C depicts a message flow diagram for a web or document search API. The API module 110, on behalf of the agent avatar module 106, may send a search request to a document database 450, as shown at arrow 452. In some embodiments, this search may be facilitated by the data module 116. The document database 450 employs a dual approach, combining sparse retrieval (as shown at block 454) with dense vector-based re-ranking (as shown at block 456). Initially, sparse retrieval, often through inverted index methods, is used for rapidly scanning extensive document collections. As shown at block 454, the document database 450 conducts the sparse retrieval search by processing structured search queries (e.g., the search request of the arrow 452) which may encompass specific filters for certain document fields and essential search terms. The document database, through this approach, identifies a relevant group of documents likely to hold the necessary information.

Given that LLMs such as the LLM 302 often have a limited context window and can be overwhelmed by excessive information in the prompt, it may be beneficial in some situations to refine the information retrieved for the LLM 302. To accomplish this, dense vector-based re-ranking is employed at block 456. This process involves a thorough analysis of the semantic links between the query and the initially retrieved documents, aiming to reorganize the documents. By doing so, the re-ranking process ensures that the final selection of documents is not only relevant but also optimally useful for addressing the specific query. This two-pronged approach is designed to maximize both the efficiency of document retrieval and the relevance and utility of the results for the LLM 302.

After the search process, the document database 450 may return the re-ranked documents to the API module 110, as shown at arrow 446. These may then be made available to the agent avatar module 106 for further analysis by the LLM 302.

In some embodiments, a similar process may be employed for searching the web.

### E. Codebase Structure

As noted above with regard to FIG. 4B, codebases such as the codebase 430 may be structured and/or indexed in a particular manner to support efficient search operations. In summary, the embodiments herein present a code database indexing method. This approach focuses on indexing target code snippets along with their relevant contexts to guarantee their executability. Additionally, this method is designed to improve RAG (as described above) for code generation, aiding in the creation of more functional code outputs.

Consider a codebase (e.g., the codebase 430 of FIG. 5A) including one or more data stories, each of which may be stored in Jupyter Notebooks and related to a workflow and represented as [symbol] ={B₁, B₂, . . . }. Each data story (e.g., data stories 504A and 504B) is a sequence of code snippets (e.g., snippets 506A, 506B, and 506C for data story 504A and snippets 506D, 506E, and 506F for data story 504B) represented as {b₁, b₂, . . . b_{N}}. Each of the data stories may be crafted to address specific research questions. To enhance the utility of these snippets, an annotation function may be used, denoted as A(⋅). This function enriches a code snippet into a more detailed structure:

$$\{ {b}_{n}^{src} , {b}_{n}^{imp} , {b}_{n}^{dep} , {b}_{n}^{dsc} \} = A ( {b}_{n} , B ) ,$$

including of several elements, as shown in the example snippet of FIG. 5B.

The first element is the actual source code 550 in the snippet,

$${b}_{n}^{src} .$$

The next three elements are the annotations 552, as described above. The second element is the imports 554

$${b}_{n}^{imp} ,$$

which may include the functions, classes, and data variables used within the 554 code 550 but defined earlier or imported from external sources. The third element is the dependencies 556,

$${b}_{n}^{dep} ,$$

which identifies the indices of other snippets within the same data story that need to be executed prior or in parallel with to this particular snippet. Finally, the description 558

$${b}_{n}^{dsc}$$

may describe the purpose and functionality of the snippet, aiding in searches (such as that depicted in FIG. 4B) and understanding the context of the code. This comprehensive annotation approach ensures each code snippet is not only contextualized but also readily searchable and understandable within the larger framework of the pipeline to which it belongs.

The annotation of code using annotations 552 facilitates both code execution and analysis planning within the broader context of the agent avatar module 106 and its operations. For execution tasks, tracking all the variables imported in the original database through these annotations provides a complete perspective of the task at hand. This comprehensive view is crucial when guiding the agent avatar module 106 to generate executable code. For analysis planning, the annotated dependencies between code snippets enable the creation of an abstract, step-by-step plan outlining the necessary actions to achieve the desired goals.

### III. EXAMPLE METHODS

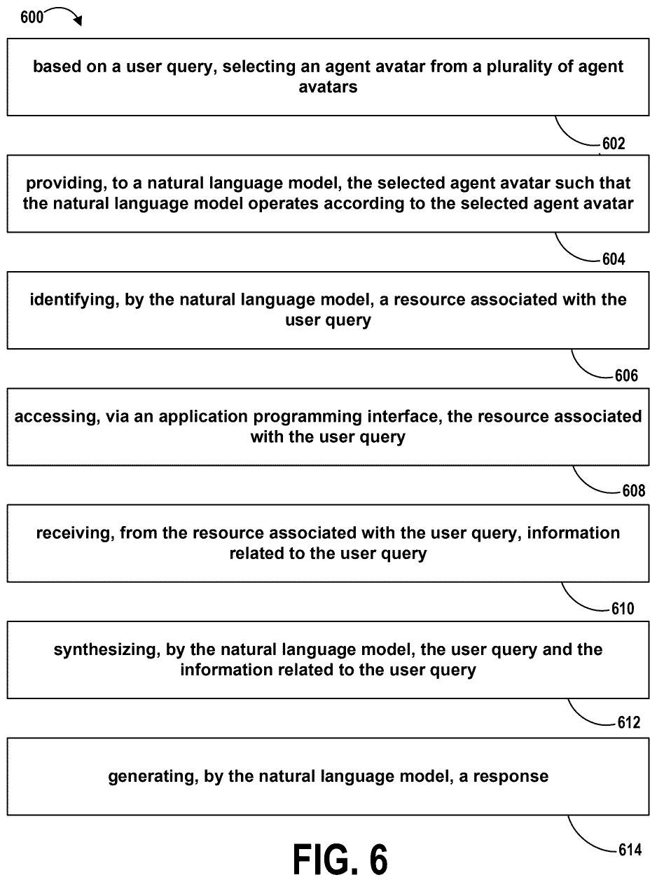

FIG. 6 is a flow chart illustrating an example embodiment. The method 600 illustrated by FIG. 6 may be carried out by a computing device. However, the process can be carried out by other types of devices or device subsystems. For example, the process could be carried out by a portable computer, such as a laptop or a tablet device.

The embodiments of FIG. 6 may be simplified by the removal of any one or more of the features shown therein. Further, these embodiments may be combined with features, aspects, and/or implementations of any of the previous figures or otherwise described herein.

Block 602 may involve, based on a user query, selecting an agent avatar from a plurality of agent avatars.

Block 604 may involve providing, to a natural language model, the selected agent avatar such that the natural language model operates according to the selected agent avatar.

Block 606 may involve identifying, by the natural language model, a resource associated with the user query.

Block 608 may involve accessing, via an application programming interface, the resource associated with the user query.

Block 610 may involve receiving, from the resource associated with the user query, information related to the user query.

Block 612 may involve synthesizing, by the natural language model, the user query and the information related to the user query.

Block 614 may involve generating, by the natural language model, a response.

In some embodiments, each agent avatar of the plurality of agent avatars corresponds to one of a plurality of operational modes. In some embodiments, the plurality of operational modes includes a code execution mode, a search-focused mode, and a reflection mode.

In some embodiments, the user query is received via a user interface. In some embodiments, the user interface comprises a chatbot interface. In some embodiments, the method may further include transmitting the response to the user interface.

In some embodiments, the user query relates to program instructions, and the information related to the user query includes suggested improvements to the program instructions. In some embodiments, the resource associated with the user query includes a server configured to execute the program instructions. In some embodiments, the server executes the program instructions in a secure environment.

In some embodiments, the resource associated with the user query includes a codebase. In some embodiments, accessing the resource associated with the user query includes transmitting, to the codebase, a search request, and receiving information related to the user query includes receiving portions of program instructions and data associated with the portions of program instructions. In some embodiments, the codebase includes a plurality of code sequences, and each of the plurality of code sequences includes one or more code elements. In some embodiments, each of the one or more code elements includes source code relating to program instructions, a listing of imported elements within the source code, a listing of code dependencies within the source code; and a textual description of a function of the source code.

In some embodiments, the resource associated with the user query includes a database. In some embodiments, accessing the resource associated with the user query includes transmitting, to the database, a search request, and receiving information related to the user query includes receiving one or more documents from the database. In some embodiments, the documents are retrieved from the database by conducting a sparse retrieval search based on the search request, and ranking, based on the search request, results of the sparse retrieval search.

In some embodiments, synthesizing the user query and the information related to the user query includes accessing a memory module and providing one or more records from the memory module to the natural language model. In some embodiments, accessing the memory module includes requesting short-term and long-term past interactions related to the natural language model and receiving, from the memory module, a record of the short-term and long-term past interactions related to the natural language model.

### IV. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like ROM, optical or magnetic disks, solid state drives, compact-disc read only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
based on a user query, selecting an agent avatar from a plurality of agent avatars;
providing, to a natural language model, the selected agent avatar such that the natural language model operates according to the selected agent avatar;
identifying, by the natural language model, a resource associated with the user query;
accessing, via an application programming interface, the resource associated with the user query;
receiving, from the resource associated with the user query, information related to the user query;
synthesizing, by the natural language model, the user query and the information related to the user query; and
generating, by the natural language model, a response.

2. The method of claim 1, wherein each agent avatar of the plurality of agent avatars corresponds to one of a plurality of operational modes.

3. The method of claim 2, wherein the plurality of operational modes comprises a code execution mode, a search-focused mode, and a reflection mode.

4. The method of claim 1, wherein the user query is received via a user interface.

5. The method of claim 4, wherein the user interface comprises a chatbot interface.

6. The method of claim 4, further comprising transmitting the response to the user interface.

7. The method of claim 1, wherein the user query relates to program instructions, and wherein the information related to the user query comprises suggested improvements to the program instructions.

8. The method of claim 7, wherein the resource associated with the user query comprises a server configured to execute the program instructions.

9. The method of claim 8, wherein the server executes the program instructions in a secure environment.

10. The method of claim 1, wherein the resource associated with the user query comprises a codebase.

11. The method of claim 10, wherein accessing the resource associated with the user query comprises transmitting, to the codebase, a search request, and wherein receiving information related to the user query comprises receiving portions of program instructions and data associated with the portions of program instructions.

12. The method of claim 10, wherein the codebase comprises a plurality of code sequences, and wherein each of the plurality of code sequences comprises one or more code elements.

13. The method of claim 12, wherein each of the one or more code elements comprises:
source code relating to program instructions;
a listing of imported elements within the source code;
a listing of code dependencies within the source code; and
a textual description of a function of the source code.

14. The method of claim 1, wherein the resource associated with the user query comprises a database.

15. The method of claim 14, wherein accessing the resource associated with the user query comprises transmitting, to the database, a search request, and wherein receiving information related to the user query comprises receiving one or more documents from the database.

16. The method of claim 15, wherein the documents are retrieved from the database by:
conducting a sparse retrieval search based on the search request; and
ranking, based on the search request, results of the sparse retrieval search.

17. The method of claim 1, wherein synthesizing the user query and the information related to the user query comprises:
accessing a memory module; and
providing one or more records from the memory module to the natural language model.

18. The method of claim 17, wherein accessing the memory module comprises:
requesting short-term and long-term past interactions related to the natural language model; and
receiving, from the memory module, a record of the short-term and long-term past interactions related to the natural language model.

19. A computing system comprising:
one or more processors;
memory; and
program instructions, stored in the memory, that upon execution by the one or more processors cause the computing system to perform operations comprising:
based on a user query, selecting an agent avatar from a plurality of agent avatars;
providing, to a natural language model, the selected agent avatar such that the natural language model operates according to the selected agent avatar;
identifying, by the natural language model, a resource associated with the user query;
accessing, via an application programming interface, the resource associated with the user query;
receiving, from the resource associated with the user query, information related to the user query;
synthesizing, by the natural language model, the user query and the information related to the user query; and
generating, by the natural language model, a response.

20. A non-transitory machine-readable medium storing program instructions that, when executed by one or more processors of a computing system, cause the computing system to perform operations comprising:
based on a user query, selecting an agent avatar from a plurality of agent avatars;
providing, to a natural language model, the selected agent avatar such that the natural language model operates according to the selected agent avatar;
identifying, by the natural language model, a resource associated with the user query;
accessing, via an application programming interface, the resource associated with the user query;
receiving, from the resource associated with the user query, information related to the user query;
synthesizing, by the natural language model, the user query and the information related to the user query; and
generating, by the natural language model, a response.
